(19) United States
(12) Patent Application Publication
(10) Pub. No.: US 2025/0293437 A1
(43) Pub. Date: Sep. 18, 2025

(54) MULTI-LAYER DIELECTRIC LENS, AND ELECTROMAGNETIC DEVICE HAVING SAME

(71) Applicant: ROGERS CORPORATION, Chandler, AZ (US)

(72) Inventors: Shailesh PANDEY, Woburn, MA (US); Kristi PANCE, Auburndale, MA (US)

(21) Appl. No.: 19/078,787

(22) Filed: Mar. 13, 2025

Related U.S. Application Data
(60) Provisional application No. 63/565,312, filed on Mar. 14, 2024.

(51) Int. Cl. H01Q 15/02; H01Q 19/06; H01Q 21/06

(52) U.S. Cl. CPC H01Q 15/02; H01Q 19/06; H01Q 21/065

(57) ABSTRACT

A lens is provided for shaping electromagnetic radiation energy originating from a signal feed when energized. The lens operates at a defined center frequency having a free space wavelength. The lens includes dielectric materials stacked side by side. An adjacent dielectric material has a dielectric constant value that is different from a dielectric constant value of another adjacent dielectric material. The dielectric materials have an overall footprint in an x-y plane and an overall thickness in a z-direction. Each cross-section of the dielectric materials in the x-y plane includes each one of the of dielectric materials. Each cross-section of the dielectric materials in one of the x-z plane and the y-z plane includes each one of the dielectric materials. At least one cross-section of the dielectric materials in the other one of the x-z plane and the y-z plane includes only one of the plurality of dielectric materials.

### CROSS REFERENCE TO RELATED APPLICATION

This application claims the benefit of U.S. Provisional Application No. 63/565,312, filed on Mar. 14, 2024, the content of which is incorporated by reference in its entirety herein.

### BACKGROUND

The present disclosure relates generally to a multi-layer dielectric lens, and an electromagnetic, EM, device, having the same.

While existing lenses and EM devices having the same may be suitable for their intended purpose, the art relating to such lenses and devices would be advanced by a construct as disclosed herein.

### BRIEF SUMMARY

An embodiment includes an EM device as defined by the appended independent claim(s). Further advantageous modifications of the EM device are defined by the appended dependent claims.

An embodiment includes a lens 1000 for use with a signal feed 2000 for shaping electromagnetic, EM, radiation energy originating from the signal feed 2000 when energized, the lens 1000 configured to operate at a defined center frequency fc having a free space wavelength λc, the lens 1000 comprising: a plurality of dielectric materials 1100 stacked side by side, wherein an adjacent one 1100.1 of the plurality of dielectric materials has a dielectric constant, Dk (sometimes referred to as “ϵᵣ,”) value that is different from a Dk value of another adjacent one 1100.2, 1100.3 of the plurality of dielectric materials 1100, the plurality of dielectric materials 1100 having an overall footprint a×b in an x-y plane and an overall thickness t in a z-direction, of an orthogonal x-y-z coordinate system; wherein each cross-section of the plurality of dielectric materials 1100 in the x-y plane comprises each one of the plurality of dielectric materials 1100; wherein each cross-section of the plurality of dielectric materials in one of; the x-z plane, and the y-z plane, comprises each one of the plurality of dielectric materials 1100; wherein at least one cross-section of the plurality of dielectric materials in the other one of; the x-z plane, and the y-z plane, comprises only one of the plurality of dielectric materials 1100.

An embodiment includes a compound lens 3000 for use with a signal feed for shaping electromagnetic, EM, radiation energy originating from the signal feed when energized, the compound lens 3000 comprising: a first of the lens 1000.1 of claim 1; a second of the lens 1000.2 of claim 1, the second lens 1000.2 being stacked on top of the first lens 1000.1, such that the overall footprint a×b of the second lens 1000.2 overlays the overall footprint a×b of the first lens 1000.1; wherein in the first lens 1000.1, each cross-section of the plurality of dielectric materials 1100 in the y-z plane comprises each one of the associated plurality of dielectric materials 1100; wherein in the first lens 1000.1, at least one cross-section of the plurality of dielectric materials in the x-z plane comprises only one of the associated plurality of dielectric materials 1100; wherein in the second lens 1000.2, each cross-section of the plurality of dielectric materials in the x-z plane comprises each one of the associated plurality of dielectric materials 1100; wherein in the second lens 1000.2, at least one cross-section of the plurality of dielectric materials in the y-z plane comprises only one of the associated plurality of dielectric materials 1100.

An embodiment includes an electromagnetic, EM, device 4000, comprising: a foregoing lens 1000 or a foregoing compound lens 3000 according to any one of the foregoing claims; and, a signal feed 2000 disposed in EM signal communication with the associated lens 1000 or compound lens 3000.

An embodiment includes an antenna array 4500, comprising: a plurality of the foregoing EM device 4000 arranged in an X-by-Y array formation 4500.

The above features and advantages and other features and advantages of the invention are readily apparent from the following detailed description of the invention when taken in connection with the accompanying drawings.

### BRIEF DESCRIPTION OF THE DRAWINGS

Referring to the exemplary non-limiting drawings wherein like elements are numbered alike in the accompanying Figures:

FIG. 1A depicts a rotated isometric view of an EM device with a slot antenna signal feed and a multi-layer lens with dielectric layers oriented parallel with the slot of the slot antenna, in accordance with an embodiment;

FIG. 1B depicts a side view of the EM device of FIG. 1A, in accordance with an embodiment;

FIG. 1C depicts a rotated isometric view of the EM device of FIG. 1A, but with an encapsulant, in accordance with an embodiment;

FIGS. 2, 3 and 4, depict various analytical performance characteristic data of the EM device of FIG. 1A, with and without a lens, in accordance with an embodiment;

FIG. 5A depicts a rotated isometric view of an EM device similar to that of FIG. 1A, but with the multi-layer lens having a greater number of layers, in accordance with an embodiment;

FIG. 5B depicts analytical performance characteristic data of the EM device of FIG. 5A, in accordance with an embodiment;

FIG. 6A depicts a rotated isometric view of the EM device of FIG. 5A, in accordance with an embodiment;

FIG. 6B depicts analytical performance characteristic data of the EM device of FIG. 6A, in accordance with an embodiment;

FIGS. 7A and 7B respectively depict: a rotated isometric view; and, a side view, of an EM device similar to that of FIG. 5A, but with the dielectric layers of the multi-layer lens oriented parallel to the direction of the dominant field direction of a patch antenna, in accordance with an embodiment;

FIGS. 7C and 7D respectively depict: an E-field vector plot only along the dominant field direction, y-axis direction, of an EM device similar to that of FIGS. 7A-7B but without the lens (WO lens); and, an H-field vector plot only along the non-dominant field direction, x-axis direction, of an EM device similar to that of FIGS. 7A-7B but without the lens (WO lens), in accordance with an embodiment;

FIGS. 7E and 7F respectively depict: a rotated isometric view; and, a side view, of an EM device similar to that of FIGS. 7A and 7B, but with a chipset as a signal feed, in accordance with an embodiment;

FIGS. 8 and 9 depict analytical performance characteristics of the embodiment of FIGS. 7A and 7B, with and without a lens, in accordance with an embodiment;

FIG. 10 depicts an analytical approach for calculating the dielectric constants of the various dielectric layers of the multilayer lens, in accordance with an embodiment;

FIGS. 11A and 11B respectively depict: a rotated isometric view; and, a top-down plan view, of a compound lens having two layers of side-by-side parallel dielectric segments, with the segments of a first layer being oriented orthogonal to the segments of a second layer, in accordance with an embodiment;

FIGS. 12A and 12B respectively depict: a rotate isometric view; and, a side view, of an EM device having the compound lens of FIGS. 11A and 11B with a patch antenna signal feed, with a legend of the Dk values of the various dielectric segments, in accordance with an embodiment;

FIGS. 13A and 13B respectively depict: a rotated isometric view of a disassembled assembly of the EM device of FIGS. 12A and 12B; and, associated analytical performance characteristics of the same, in accordance with an embodiment;

FIGS. 14A and 14B respectively depict: a top-down plan view of the EM device of FIGS. 12A and 12B; and, associated analytical performance characteristics of the same in the dominant field direction, in accordance with an embodiment;

FIGS. 15A and 15B respectively depict: a top-down plan view of the EM device of FIGS. 12A and 12B; and, associated analytical performance characteristics of the same along the non-dominant field direction, in accordance with an embodiment; and

FIG. 16 depicts an X-by-Y array of an EM device as described and depicted herein, with ellipses representative of an array of any size, in accordance with an embodiment.

One skilled in the art will understand that the drawings, further described herein below, are for illustration purposes only. It will be appreciated that for simplicity and clarity of illustration, elements shown in the figures have not necessarily been drawn to scale. For example, the dimensions or scale of some of the elements may be exaggerated relative to other elements for clarity. Further, where considered appropriate, reference numerals may be repeated among the figures to indicate corresponding or analogous elements, or analogous elements may not be repetitively enumerated in all figures where it will be appreciated and understood that such enumeration where absent is inherently disclosed.

### DETAILED DESCRIPTION

As used herein, the phrase “embodiment” means “embodiment disclosed and/or illustrated herein”, which may not necessarily encompass a specific embodiment of an invention in accordance with the appended claims, but nonetheless is provided herein as being useful for a complete understanding of an invention in accordance with the appended claims.

Although the following detailed description contains many specifics for the purposes of illustration, anyone of ordinary skill in the art will appreciate that many variations and alterations to the following details are within the scope of the appended claims. For example, where described features may not be mutually exclusive of and with respect to other described features, such combinations of non-mutually exclusive features are considered to be inherently disclosed herein. Additionally, common features may be commonly illustrated in the various figures but may not be specifically enumerated in all figures for simplicity, but would be recognized by one skilled in the art as being an explicitly disclosed feature even though it may not be enumerated in a particular figure. Accordingly, the following example embodiments are set forth without any loss of generality to, and without imposing limitations upon, the claimed invention disclosed herein.

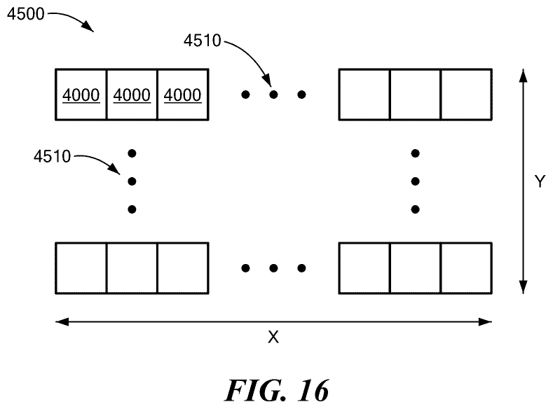

An embodiment, as shown and described by the various figures and accompanying text, provides a lens or compound lens and an EM device having the same, where the EM device may be arranged in an X-by-Y array. While certain embodiments described and/or illustrated herein depict a certain size array (FIG. 16, for example), it will be appreciated that the disclosed invention is not so limited and also encompasses other sized arrays.

As used herein, the term “unitary,” “monolith,” or “monolithic,” for example, is a unitary component or a monolith or monolithic structure, refers to a three-dimensional construction, e.g., one body, that can be formed from portions that can have substantially identical or identical compositions. A monolith can be made of a single, continuous material, e.g., thermoplastic material, and can be manufactured using various techniques, including injection molding, compression molding, 3D printing, and extrusion. Accordingly, a unitary component differs from a laminate or assembly of differing constituents, which includes an interface between differing constituents thereof. A unitary component can be integrally formed, for example, integrally molded in a single mold. Similarly, as used herein, portions can be “integrally formed,” or one portion can be “integrally formed” with a different portion, resulting in a unitary component differing from a laminate or assembly of differing constituents, which includes an interface between differing constituents thereof.

While embodiments described and/or illustrated herein depict lenses or compound lends having a particular cross-section profile (x-y, x-z, or y-z), it will be appreciated that such profiles may be modified without departing from a scope of the invention. As such, any profile that falls within the ambit of the disclosure herein, and is suitable for a purpose disclosed herein, is contemplated and considered to be complementary to the embodiments disclosed herein.

While the following example embodiments are individually presented, it will be appreciated from a complete reading of all of the embodiments described herein below that similarities may exist among the individual embodiments that would enable some cross over of features and/or processes. As such, combinations of any of such individual features and/or processes may be employed in accordance with an embodiment, whether or not such combination is explicitly illustrated, while remaining consistent with the disclosure herein. The several figures associated with one or more of the following example embodiments depict an orthogonal set of x-y-z axes that provide a frame of reference for the structural relationship of corresponding features with respect to each other, where an x-y plane coincides with a plan view, and an x-z or y-z plane coincides with an elevation view, of the corresponding embodiments.

As used herein, the phrase “having a Dk material other than air” necessarily includes a Dk material that is not air, but may also include air, which includes a foam for example. As used herein, the phrase “comprising air” necessarily includes air, but also does not preclude a Dk material that is not air, which includes a foam for example. Also, the term “air” may more generally be referred to and viewed as being a gas having a dielectric constant that is suitable for a purpose disclosed herein.

While certain combinations of individual features have been described and illustrated herein, it will be appreciated that these certain combinations of features are for illustration purposes only and that any combination of any of such individual features may be employed in accordance with an embodiment, whether or not such combination is explicitly illustrated, and consistent with the disclosure herein. Any and all such combinations of features as disclosed herein are contemplated herein, are considered to be within the understanding of one skilled in the art when considering the application as a whole, and are considered to be within the scope of the invention disclosed herein, as long as they fall within the scope of the invention defined by the appended claims, in a manner that would be understood by one skilled in the art.

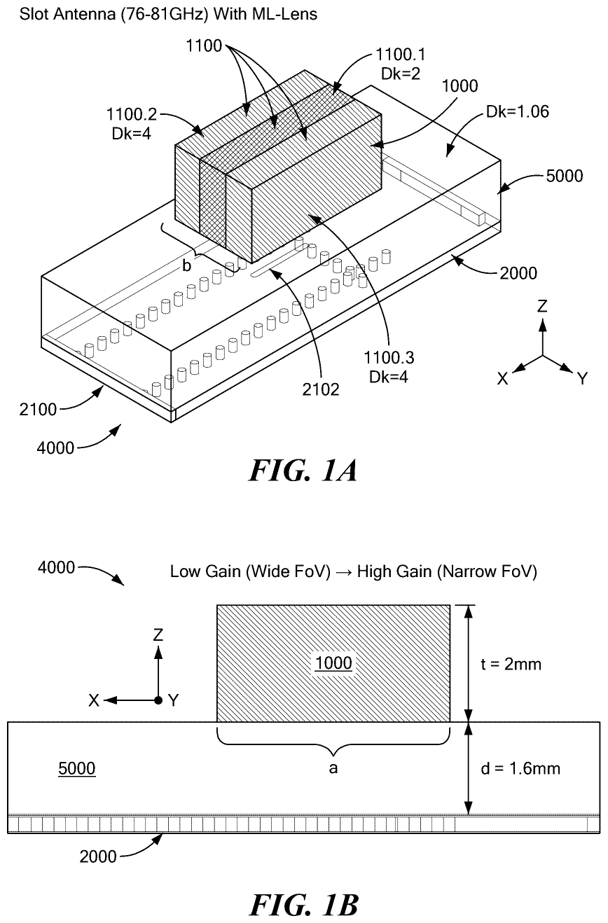

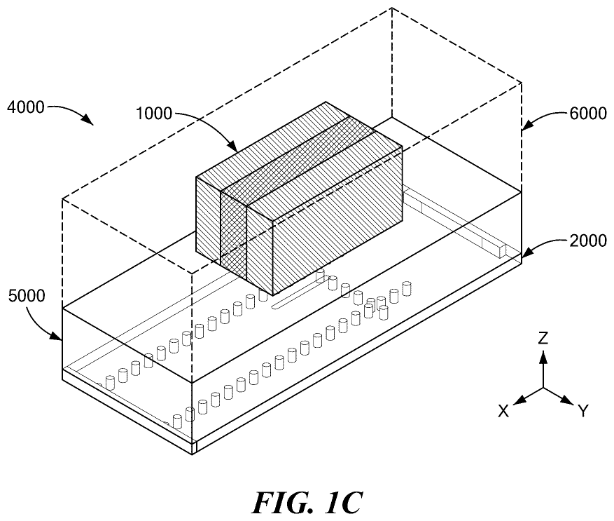

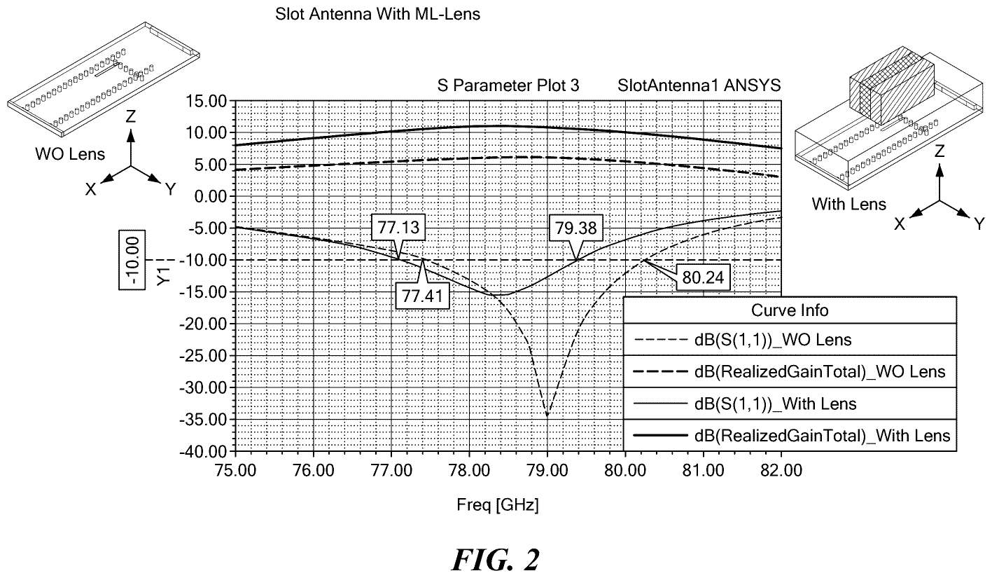

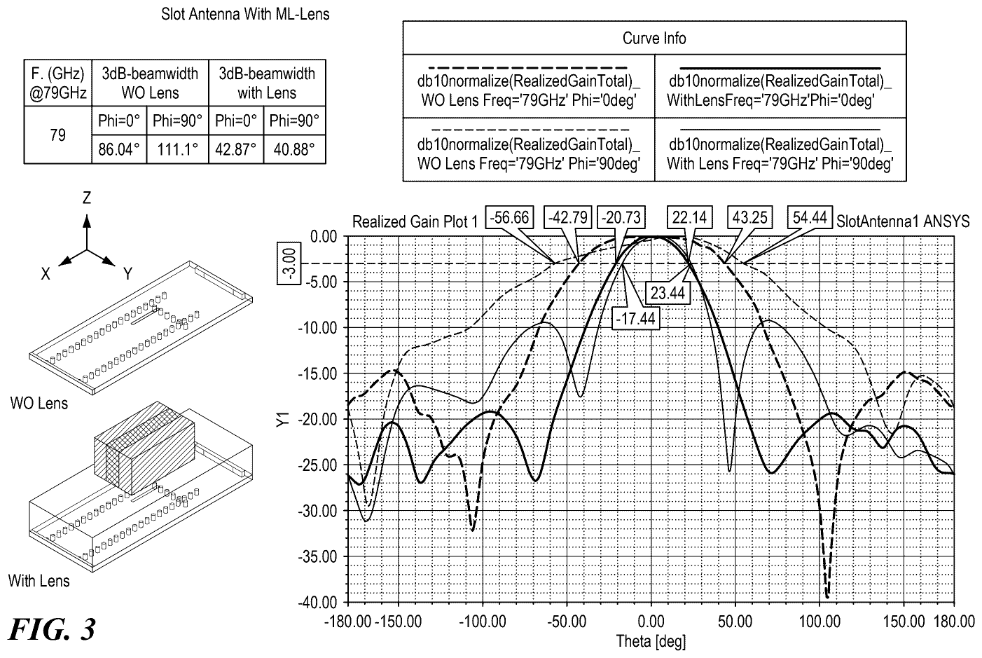

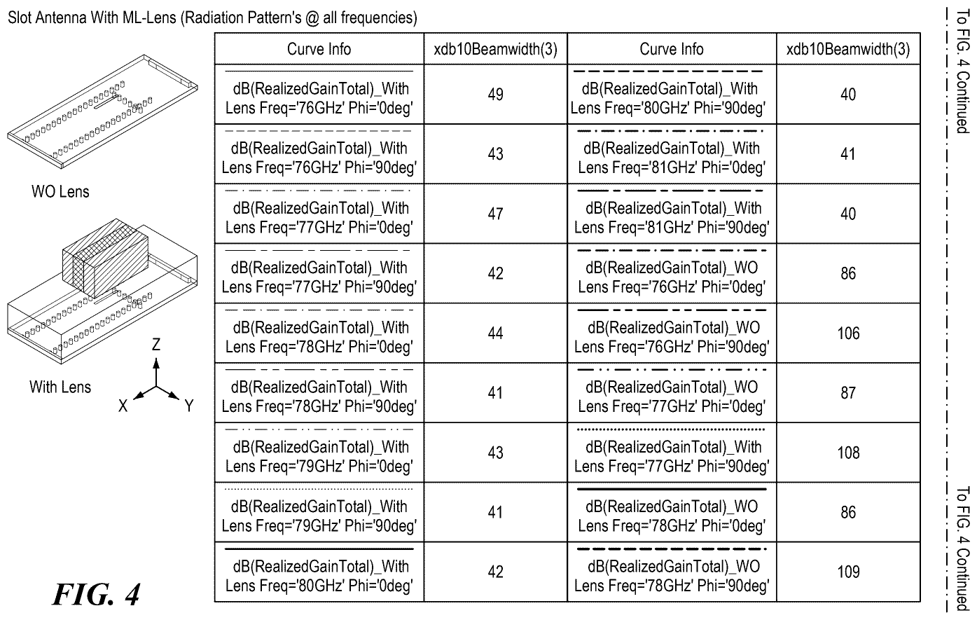

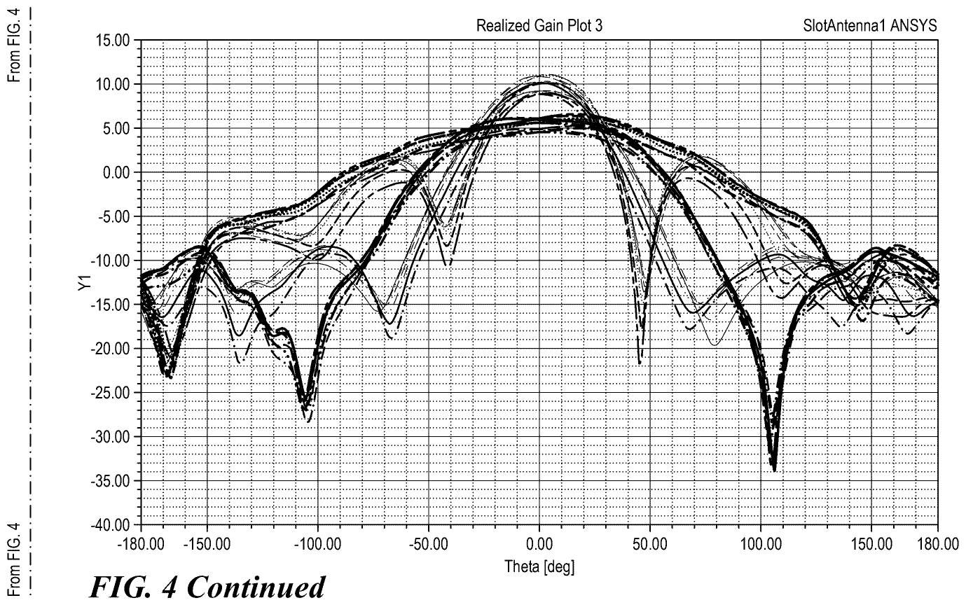

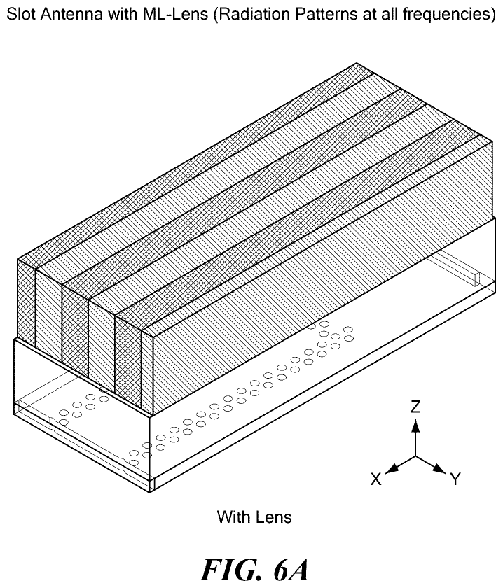

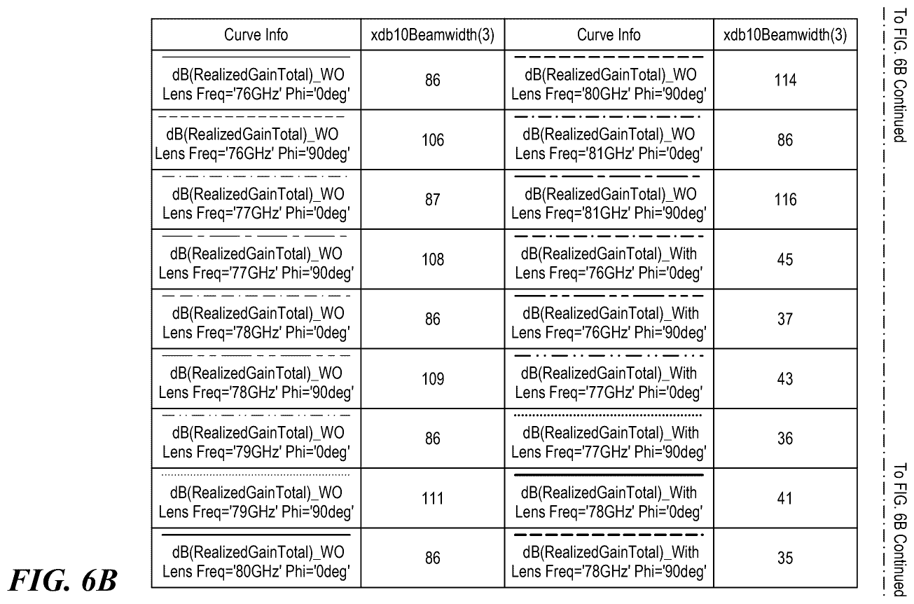

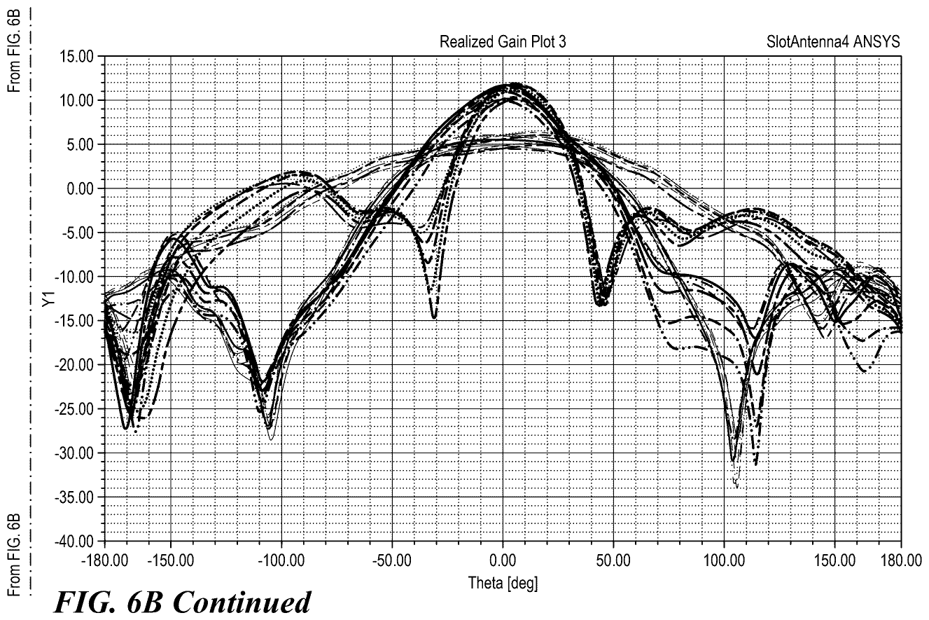

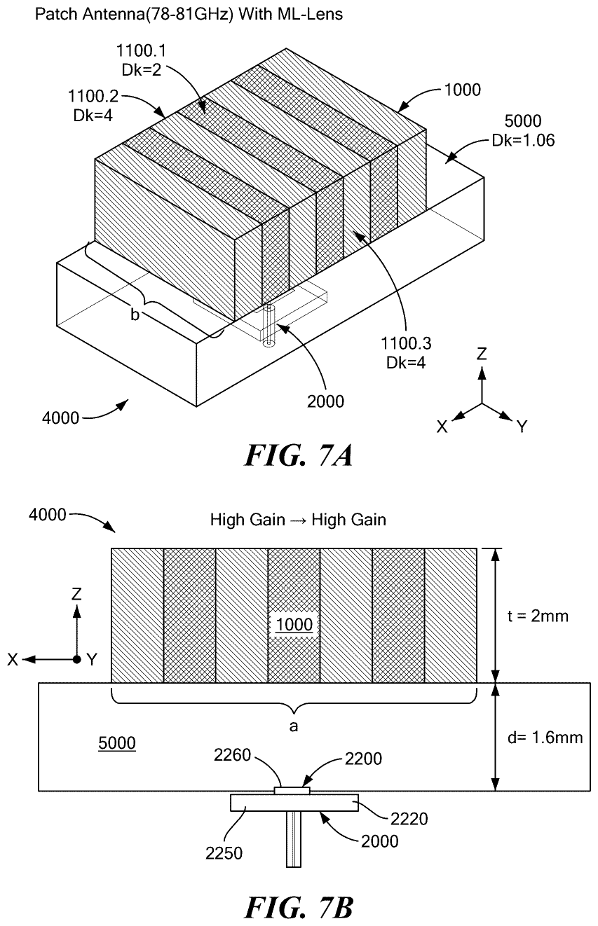

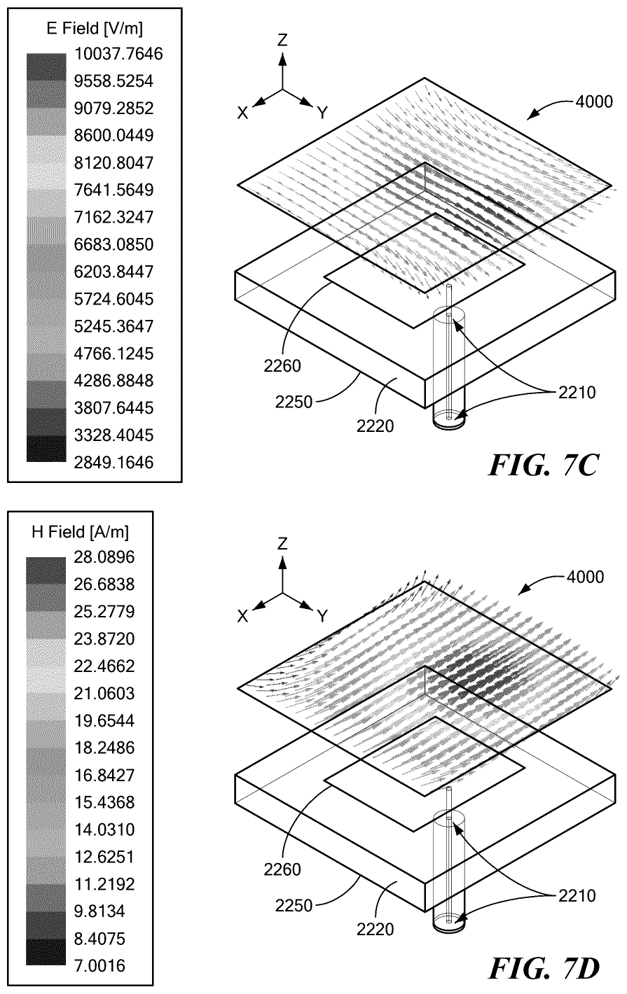

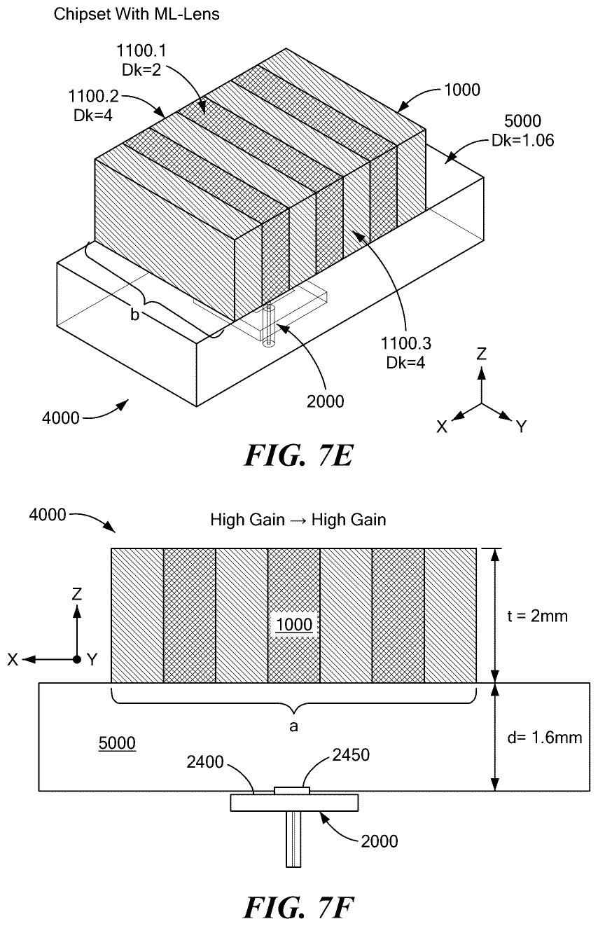

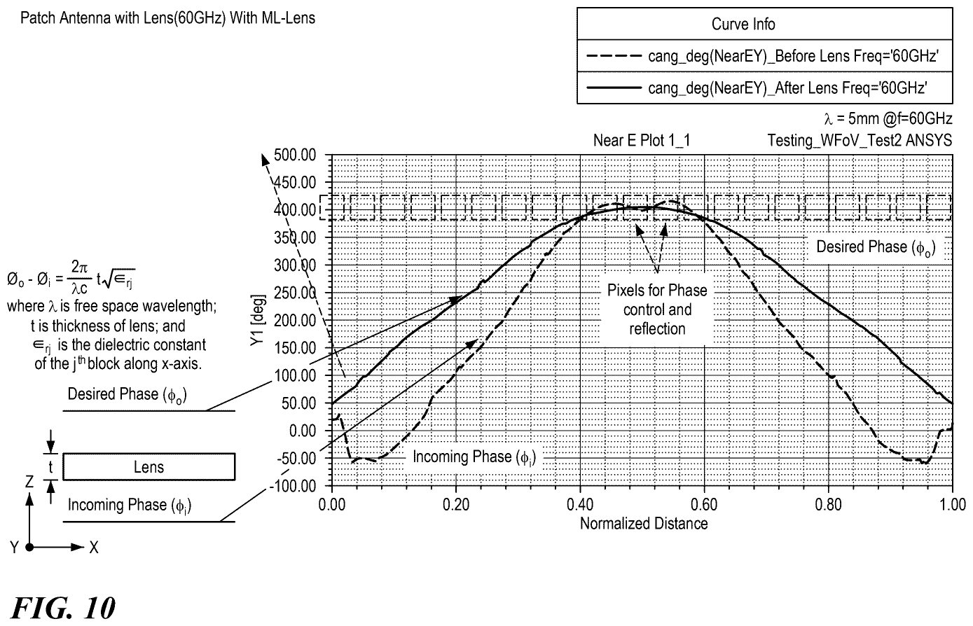

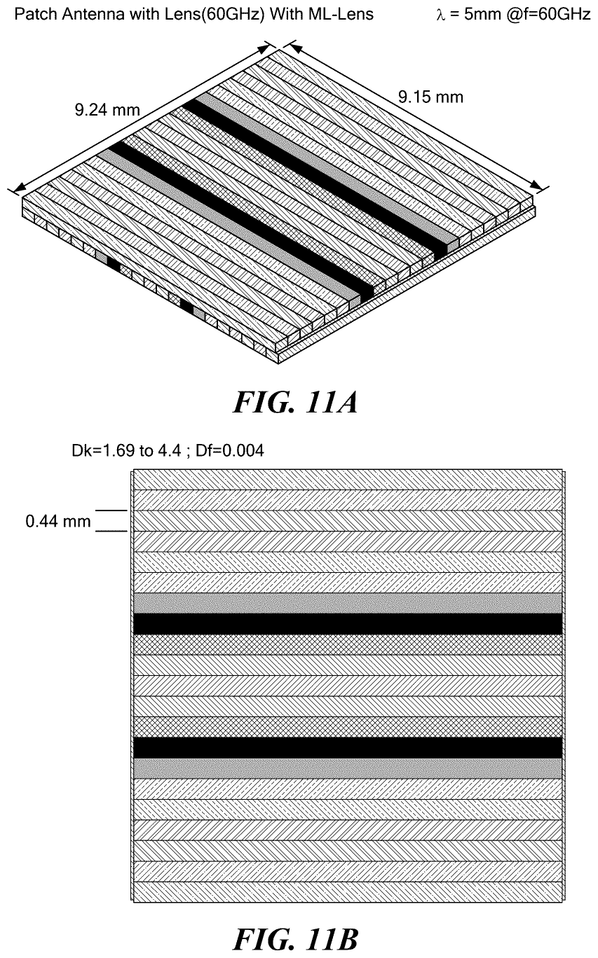

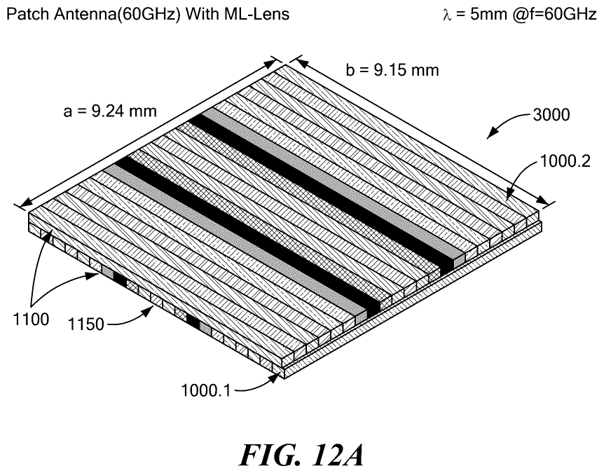

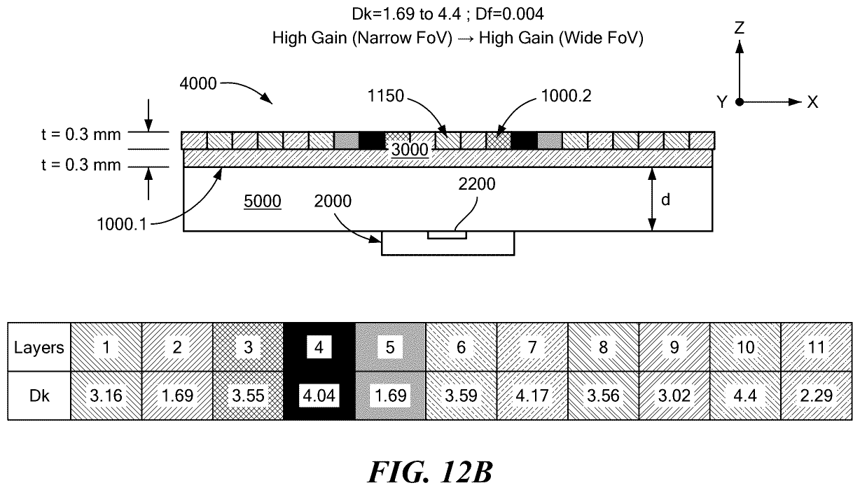

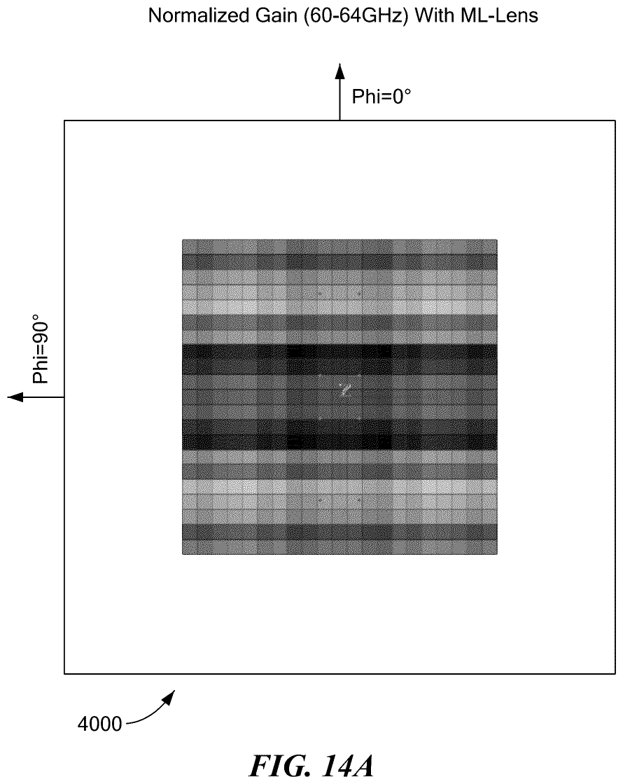

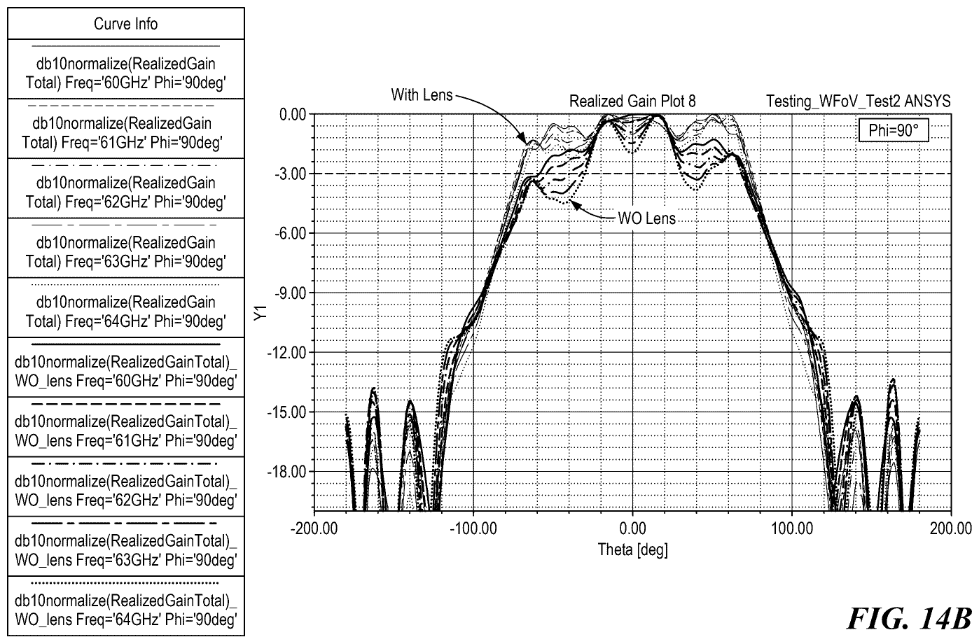

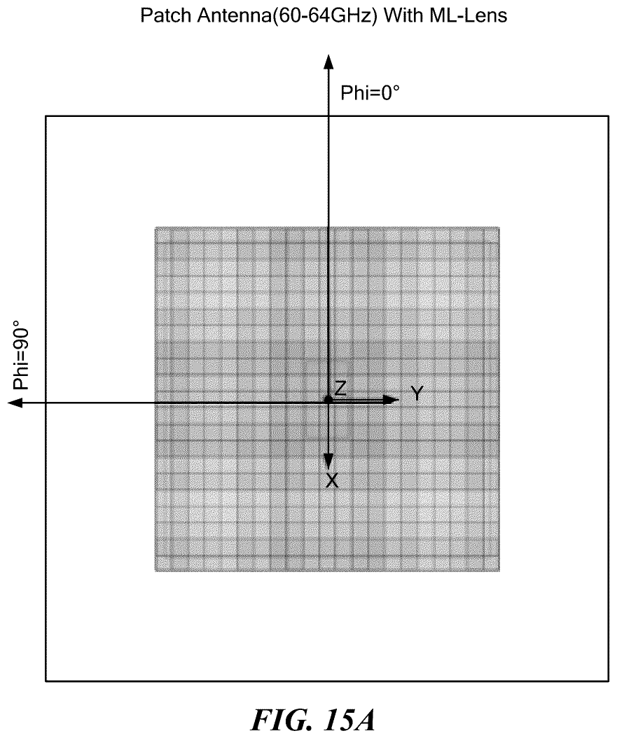

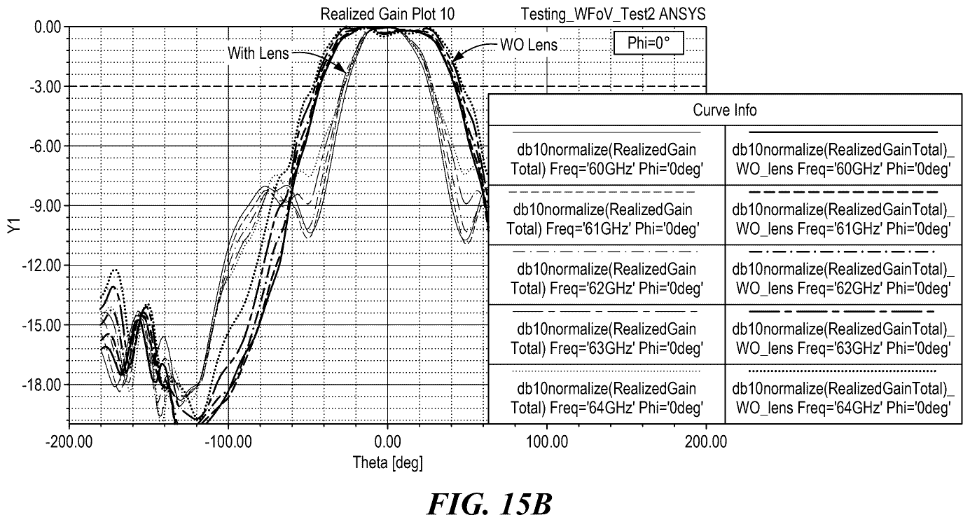

With respect to the several figures of FIGS. 1A-16, it will be appreciated that various aspects of an embodiment are disclosed herein, which are in accordance with, but not limited to, at least the following aspects and/or combinations of aspects.
Aspect 1 (see FIGS. 1A, 1B, 7A, and 7B, for example): A lens 1000 for use with a signal feed 2000 for shaping electromagnetic, EM, radiation energy originating from the signal feed 2000 when energized, the lens 1000 configured to operate at a defined center frequency fc having a free space wavelength λc, the lens 1000 comprising: a plurality of dielectric materials 1100 stacked side by side, wherein an adjacent one 1100.1 of the plurality of dielectric materials has a dielectric constant, Dk, value that is different from a Dk value of another adjacent one 1100.2, 1100.3 of the plurality of dielectric materials 1100, the plurality of dielectric materials 1100 having an overall footprint a×b in an x-y plane and an overall thickness t in a z-direction, of an orthogonal x-y-z coordinate system; wherein each cross-section of the plurality of dielectric materials 1100 in the x-y plane comprises each one of the plurality of dielectric materials 1100; wherein each cross-section of the plurality of dielectric materials in one of; the x-z plane, and the y-z plane, comprises each one of the plurality of dielectric materials 1100; wherein at least one cross-section of the plurality of dielectric materials in the other one of; the x-z plane, and the y-z plane, comprises only one of the plurality of dielectric materials 1100.
Aspect 2: The lens 1000 of Aspect 1, wherein: the plurality of dielectric materials 1100 has an extrudable construct in both the z-direction and the x-direction.
Aspect 3: The lens 1000 of Aspect 1, wherein: the plurality of dielectric materials 1100 has an extrudable construct in both the z-direction and the y-direction.
Aspect 4: The lens 1000 of any one of the foregoing Aspects, wherein: the plurality of dielectric materials 1100 comprises an alternating arrangement of a first dielectric material 1100.1 having a first Dk value (Dk=2 for example), and a second dielectric material 1100.2 having a second Dk value (Dk=4 for example) different from the first Dk value.
Aspect 5: The lens 1000 of Aspect 4, wherein: the second Dk value (Dk=4 for example) is at least two times the first Dk value (Dk=2 for example).
Aspect 6: The lens 1000 of Aspect 5, wherein: the first Dk value is 2, and the second Dk value is 4.
Aspect 7: The lens 1000 of any one of the foregoing Aspects, wherein: the plurality of dielectric materials 1100 is in the form of a cuboid (see FIGS. 1 & 7 for example).
Aspect 8: The lens 1000 of any one of the foregoing Aspects, wherein: each dielectric material of the plurality of dielectric materials 1100 is composed of a dielectric-only material.
Aspect 9 (see FIG. 12 for example): A compound lens 3000 for use with a signal feed for shaping electromagnetic, EM, radiation energy originating from the signal feed when energized, the compound lens 3000 comprising: a first of the lens 1000.1 of Aspect 1; a second of the lens 1000.2 of Aspect 1, the second lens 1000.2 being stacked on top of the first lens 1000.1, such that the overall footprint a×b of the second lens 1000.2 overlays the overall footprint a×b of the first lens 1000.1; wherein in the first lens 1000.1, each cross-section of the plurality of dielectric materials 1100 in the y-z plane comprises each one of the associated plurality of dielectric materials 1100; wherein in the first lens 1000.1, at least one cross-section of the plurality of dielectric materials in the x-z plane comprises only one of the associated plurality of dielectric materials 1100; wherein in the second lens 1000.2, each cross-section of the plurality of dielectric materials in the x-z plane comprises each one of the associated plurality of dielectric materials 1100; wherein in the second lens 1000.2, at least one cross-section of the plurality of dielectric materials in the y-z plane comprises only one of the associated plurality of dielectric materials 1100.
Aspect 10: The compound lens 3000 of Aspect 9, wherein: the second lens 1000.2 has an identical side by side stack up of the plurality of dielectric materials 1100 as the first lens 1000.1.
Aspect 11: The compound lens 3000 of Aspect 10, wherein: the first lens 1000.1 and the second lens 1000.2 each have an odd number of the plurality of dielectric materials 1100.
Aspect 12: The compound lens 3000 of Aspect 11, wherein: the plurality of dielectric materials 1100 of the first lens 1000.1 has mirror image symmetry in the x-z plane about the associated central one 1150 of the plurality of dielectric materials 1100; the plurality of dielectric materials 1100 of the second lens 1000.2 has mirror image symmetry in the y-z plane about the associated central one 1150 of the plurality of dielectric materials 1100.
Aspect 13 (see FIG. 10 for example): The compound lens 3000 of any one of Aspects 10 to 12, wherein: each dielectric material of the plurality of dielectric materials 1100 of the first lens 1000.1 has a Dk value that is initially calculated according to the following equation and then tuned based on desired performance characteristics:

$$ϕ o - ϕ i = 2 π / λ c * t * SQRT ( D kj ) ;$$

where:
   ϕi is a known incoming phase angle of the EM radiation to the compound lens;
   ϕo is a desired output phase angle of the EM radiation from the compound lens;
Dkj (also referred to as “ϵᵣⱼ,”) is the Dk value of the jth dielectric material of the plurality of dielectric materials along the non-dominant field direction;
λc is the free space wavelength of the compound lens 3000 when operating at the desired center frequency fc; and
t is the thickness of the plurality of dielectric materials 1100 in the z-direction.

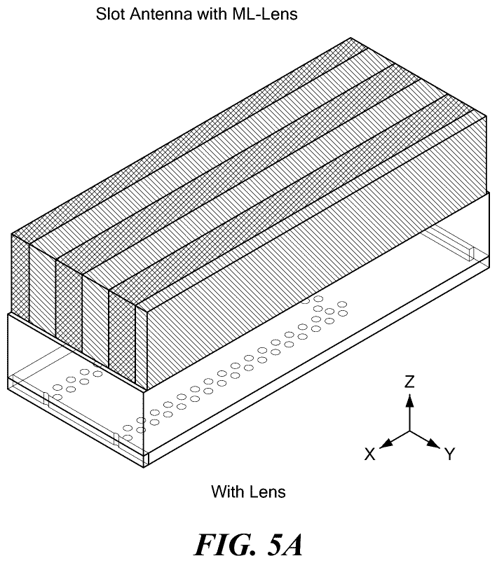

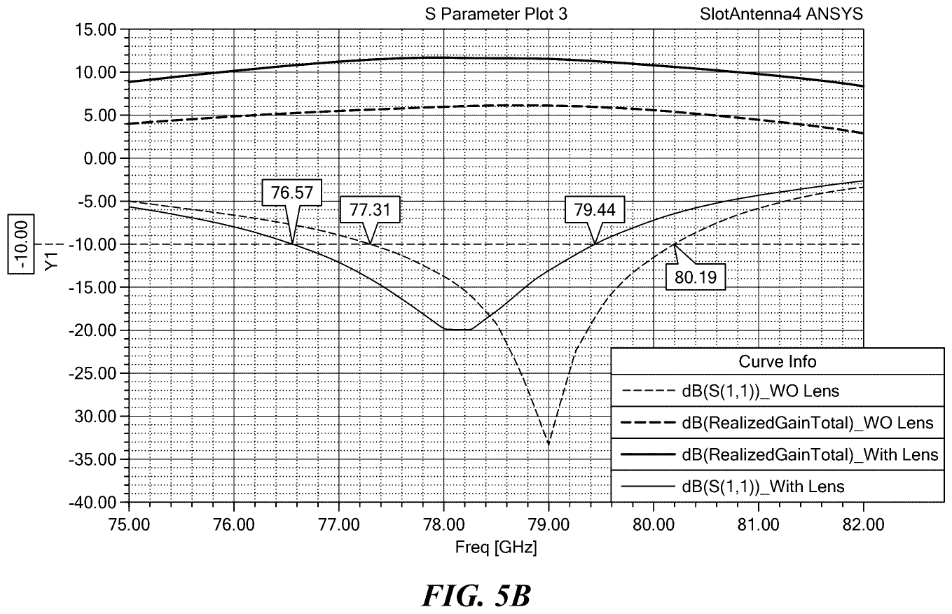

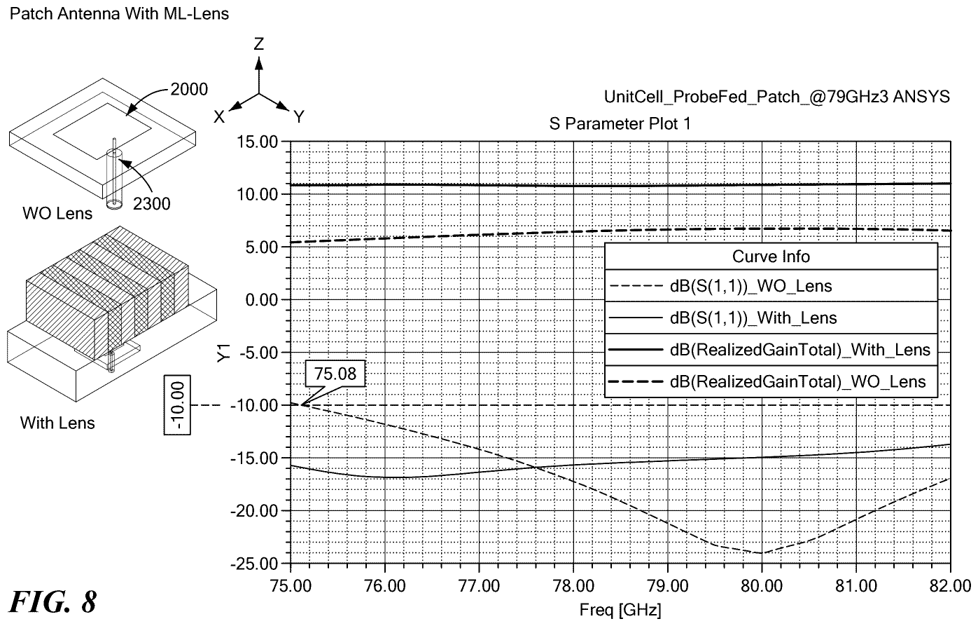

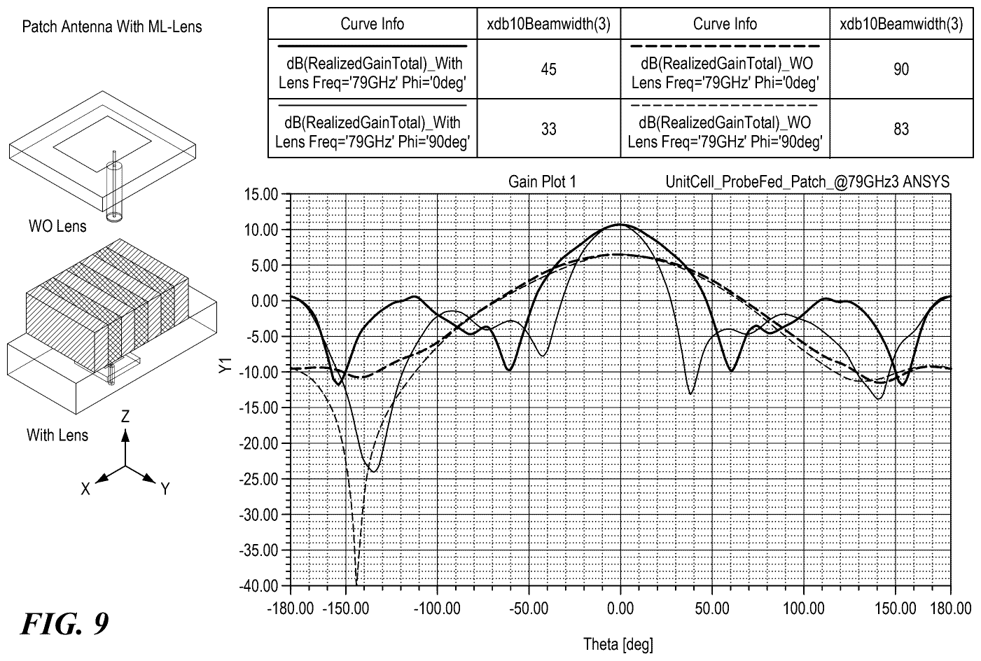

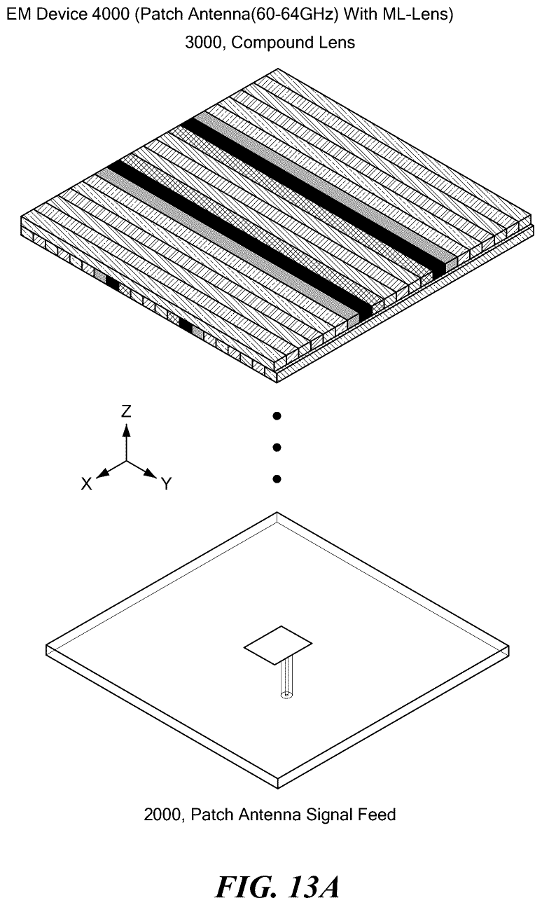

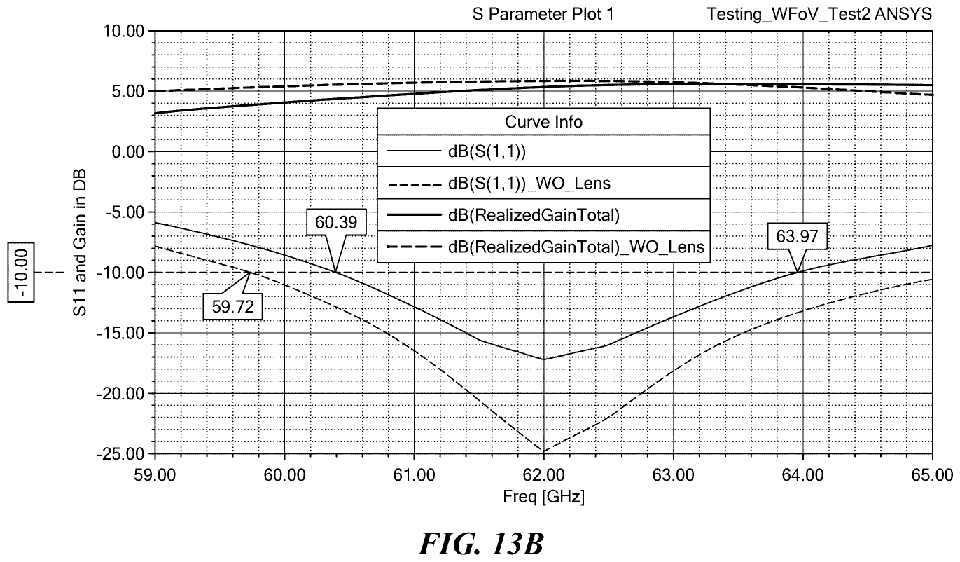

In a non-limiting embodiment, the dielectric constants (ϵᵣⱼ) are calculated based on the desired phase's coming out of lens, where epsilon (E) is calculated using one or more pixels (i.e., for phase control and reduced reflection approach) along x-axis, and then repeated along y-axis with the desired phase's along those line segments.
Aspect 14 (see at least FIGS. 1A, 1B, and 13, for example): An electromagnetic, EM, device 4000, comprising: a lens 1000 or a compound lens 3000 according to any one of the foregoing Aspects; and, a signal feed 2000 disposed in EM signal communication with the associated lens 1000 or compound lens 3000.
Aspect 15: The EM device 4000 of Aspect 14, wherein: the associated lens 1000 or compound lens 3000 is disposed a distance d above the signal feed 2000.
Aspect 16: The EM device 4000 of Aspect 15, wherein: the distance d is initially set equal to λ/2, and subsequently tuned to get an exact distance to achieve a desired phase center of the associated lens 1000 or compound lens 3000, where the EM device 4000 is operational at the center frequency fc having an associated free space wavelength λc.
Aspect 17: The EM device 4000 of any one of Aspects 15 to 16, further comprising: a dielectric spacer 5000 disposed between the signal feed 2000 and the associated lens 1000 or compound lens 3000.
Aspect 18: The EM device 4000 of Aspect 17, wherein: the dielectric spacer 5000 is disposed on the signal feed 2000; and, the associated lens 1000 or compound lens 3000 is disposed on the dielectric spacer 5000.
Aspect 19: The EM device 4000 of any one of Aspects 17 to 18, wherein: the dielectric spacer 5000 has a Dk value of greater than 1 and less than 1.5.
Aspect 20: The EM device 4000 of any one of Aspects 17 to 19, further comprising: a dielectric encapsulant 6000 disposed over and fixturing the lens 1000 or compound lens 3000 to the dielectric spacer 5000 and signal feed 2000.
Aspect 21: The EM device 4000 of Aspect 20, wherein: the dielectric encapsulant 6000 has a Dk value of greater than 1 and less than 1.5.
Aspect 22 (see FIGS. 1A and 1B, for example): The EM device 4000 of any one of Aspects 14 to 21, wherein: the signal feed 2000 comprises a waveguide 2100 and a slotted aperture 2102.
Aspect 23 (see FIGS. 1A and 1B, for example): The EM device 4000 of Aspect 22, wherein: the overall footprint a×b of the associated lens 1000 or compound lens 3000 overlays at least the slotted apertures 2102.
Aspect 24 (see FIG. 5A for example): The EM device 4000 of any one of Aspects 22 to 23, wherein: the overall footprint a×b of the associated lens 1000 or compound lens 3000 overlays the waveguide 2100 and slotted aperture 2102. In an embodiment, the greater number of layers of dielectric materials 1100 are extended to cover the source to reduce the E-field diffractions and concentrate the E-field emanating from the source.
Aspect 25 (see FIG. 7A-7D for example): The EM device 4000 of any one of Aspects 14 to 21, wherein: the signal feed 2000 comprises a patch antenna 2200 comprising a signal line 2210 that passes through a ground plane 2250 and a dielectric substrate 2220 disposed on the ground plane 2250, and a conductive patch 2260 disposed on the dielectric substrate 2220, the signal line 2210 being disposed in electrical communication with the conductive patch 2260. In an embodiment, as depicted in FIGS. 7A-7D, the source used for the dielectric layers 1100 of the multi-layer lens 1000 is a patch antenna 2200, where the layers 1100 of the multi-layer lens 1000 are oriented parallel to the direction of the dominant field direction of the patch antenna 2200. As is well known in the art, a patch antenna 2200 radiates in its dominant field, which refers to the electric field, E-field, pattern that characterizes the antenna's radiation. This dominant field is also defined as the polarization of an antenna in which the respective E-plane is oriented, which in FIGS. 7A-7B is predominantly in the y-axis direction (see FIG. 7C for example). Similarly, a patch antenna 2200 also radiates H-field or H-plane radiation distributions, which is oriented predominantly in the x-axis direction (see FIG. 7D for example). The dominant field is typically the E-field that exists between the conductive patch (radiating element) 2260 and the ground plane 2250, or the portion of the dielectric substrate 2220 beneath the conductive patch 2260. The dominant E-field is responsible for setting up and tuning the communication links between transmitter and receiver antennas. The specific characteristics of the dominant field, including its field distribution and energy, depend on the dimensions and shape of the patch, the dielectric properties of the materials employed, and the frequency for which the antenna is designed. The dominant field is also used in characterizing antenna performances in terms of radiation efficiency and directivity. As depicted in FIGS. 7C-7D, the respective predominant directions of the E-field and H-field are illustrated absent the lens 1000 (no lens 1000 depicted), which can also be seen in FIGS. 8-9.
Aspect 26 (see FIG. 7E-7F for example): The EM device 4000 of any one of Aspects 14 to 21, wherein: the signal feed 2000 comprises a chipset 2400 with at least one radiating element 2450.
Aspect 27: The EM device 4000 of Aspect 26, wherein: the overall footprint a×b of the associated lens 1000 or compound lens 3000 overlays at least the signal feed 2000.
Aspect 28: The EM device 4000 of Aspect 25, wherein: the overall footprint a×b of the associated lens 1000 or compound lens 3000 overlays the patch antenna 2200, which comprises the signal line 2210, the conductive patch 2260, at least that portion of the dielectric substrate 2220 beneath the conductive patch 2260, and a corresponding portion of the ground plane 2250.
Aspect 29 (see FIGS. 1A and 1B, for example) The EM device 4000 of any one of Aspects 22 to 24 (slotted aperture) and the lens 1000 of Aspects 1-8, wherein: the slotted aperture 2102 is linearly aligned with the x-axis; each cross-section of the plurality of dielectric materials 1100 in the y-z plane comprises each one of the plurality of dielectric materials 1100; and, at least one cross-section of the plurality of dielectric materials 1100 in the x-z plane comprises only one of the plurality of dielectric materials 1100.
Aspect 30 (see FIGS. 7A and 8, for example): The EM device 4000 of any one of Aspects 25 to 28 (patch) and the lens 1000 of Aspects 1-8, wherein: a signal line 2300 to the patch 2200 is configured to produce an E-field linearly aligned with the y-axis; each cross-section of the plurality of dielectric materials 1100 in the x-z plane comprises each one of the plurality of dielectric materials 1100; and, at least one cross-section of the plurality of dielectric materials 1100 in the y-z plane comprises only one of the plurality of dielectric materials 1100.
Aspect 31 (see FIGS. 8 and 13, for example): The EM device 4000 of any one of Aspects 25 to 28 (patch) and the compound lens 3000 of Aspects 9-13, wherein: a signal line 2300 to the patch 2200 is configured to produce an E-field linearly aligned with the y-axis; in the first lens 1000.1, each cross-section of the plurality of dielectric materials 1100 in the y-z plane comprises each one of the plurality of dielectric materials 1100; and, in the first lens 1000.1, at least one cross-section of the plurality of dielectric materials 1100 in the x-z plane comprises only one of the plurality of dielectric materials 1100.
Aspect 32 (see FIG. 16 for example): An antenna array, comprising: a plurality of the EM device 4000 of any one of Aspects 25 to 28 arranged in an X-by-Y array formation 4500. As depicted in FIG. 16, a schematic representation of an array 4500 includes a plurality of the devices 4000 (other figures and descriptions provided herein define the device 4000), where the ellipses 4510 represent an expansion of the plurality of the devices 4000 in the array 4500 of any size in the X & Y directions falling within an ambit of the appended claims.

While an invention has been described herein with reference to example embodiments, it will be understood by those skilled in the art that various changes may be made and equivalents may be substituted for elements thereof without departing from the scope of the claims. Many modifications may be made to adapt a particular situation or material to the teachings of the invention without departing from the essential scope thereof. Therefore, it is intended that the invention not be limited to the particular embodiment or embodiments disclosed herein as the best or only mode contemplated for carrying out this invention, but that the invention will include all embodiments falling within the scope of the appended claims. In the drawings and the description, there have been disclosed example embodiments and, although specific terms and/or dimensions may have been employed, they are unless otherwise stated used in a generic, exemplary and/or descriptive sense only and not for purposes of limitation, the scope of the claims therefore not being so limited. When an element such as a layer, film, region, substrate, or other described feature is referred to as being “on” or in “engagement with” another element, it can be directly on or engaged with the other element, or intervening elements may also be present. In contrast, when an element is referred to as being “directly on” or “directly engaged with” another element, there are no intervening elements present. The use of the terms first, second, etc. do not denote any order or importance, but rather the terms first, second, etc. are used to distinguish one element from another. The use of the terms a, an, etc. do not denote a limitation of quantity, but rather denote the presence of at least one of the referenced item. The use of the terms “top”, “bottom”, “up”, “down”, “left”, “right”, “front”, “back”, etc., or any reference to orientation, do not denote a limitation of structure, as the structure may be viewed from more than one orientation, but rather denote a relative structural relationship between one or more of the associated features as disclosed herein. The term “comprising” as used herein does not exclude the possible inclusion of one or more additional features. And, any background information provided herein is provided to reveal information believed by the applicant to be of possible relevance to the invention disclosed herein. No admission is necessarily intended, nor should be construed, that any of such background information constitutes prior art against an embodiment of the invention disclosed herein.

1. A lens for use with a signal feed for shaping electromagnetic (EM) radiation energy originating from the signal feed when energized, the lens configured to operate at a defined center frequency (fc) having a free space wavelength (λc), the lens comprising:
a plurality of dielectric materials stacked side by side, wherein an adjacent one of the plurality of dielectric materials has a dielectric constant (Dk) value that is different from a Dk value of another adjacent one of the plurality of dielectric materials, the plurality of dielectric materials having an overall footprint (a×b) in an x-y plane and an overall thickness (t) in a z-direction, of an orthogonal x-y-z coordinate system;
wherein each cross-section of the plurality of dielectric materials in the x-y plane comprises each one of the plurality of dielectric materials;
wherein each cross-section of the plurality of dielectric materials in one of; the x-z plane, and the y-z plane, comprises each one of the plurality of dielectric materials;
wherein at least one cross-section of the plurality of dielectric materials in the other one of; the x-z plane, and the y-z plane, comprises only one of the plurality of dielectric materials.

2. The lens of claim 1, wherein:
the plurality of dielectric materials has an extrudable construct in both the z-direction and the x-direction.

3. The lens of claim 1, wherein:
the plurality of dielectric materials has an extrudable construct in both the z-direction and the y-direction.

4. The lens of claim 1, wherein:
the plurality of dielectric materials comprises an alternating arrangement of a first dielectric material having a first Dk value (Dk=2 for example), and a second dielectric material having a second Dk value (Dk=4 for example) different from the first Dk value.

5. The lens of claim 4, wherein:
the second Dk value (Dk=4 for example) is at least two times the first Dk value (Dk=2 for example).

6. The lens of claim 5, wherein:
the first Dk value is 2, and the second Dk value is 4.

7. The lens of claim 1, wherein:
the plurality of dielectric materials is in the form of a cuboid.

8. The lens of claim 1, wherein:
each dielectric material of the plurality of dielectric materials is composed of a dielectric-only material.

9. A compound lens for use with a signal feed for shaping electromagnetic, EM, radiation energy originating from the signal feed when energized, the compound lens comprising:
a first lens and a second lens, the second lens being stacked on top of the first lens, such that the overall footprint (a×b) of the second lens overlays the overall footprint (a×b) of the first lens,
wherein each of the first lens and the second lens comprises:
a plurality of dielectric materials stacked side by side, wherein an adjacent one of the plurality of dielectric materials has a dielectric constant (Dk) value that is different from a Dk value of another adjacent one of the plurality of dielectric materials, the plurality of dielectric materials having an overall footprint (a×b) in an x-y plane and an overall thickness (t) in a z-direction, of an orthogonal x-y-z coordinate system;
wherein each cross-section of the plurality of dielectric materials in the x-y plane comprises each one of the plurality of dielectric materials;
wherein each cross-section of the plurality of dielectric materials in one of; the x-z plane, and the y-z plane, comprises each one of the plurality of dielectric materials;
wherein at least one cross-section of the plurality of dielectric materials in the other one of; the x-z plane, and the y-z plane, comprises only one of the plurality of dielectric materials,
wherein in the first lens, each cross-section of the plurality of dielectric materials in the y-z plane comprises each one of the associated plurality of dielectric materials;
wherein in the first lens, at least one cross-section of the plurality of dielectric materials in the x-z plane comprises only one of the associated plurality of dielectric materials,
wherein in the second lens, each cross-section of the plurality of dielectric materials in the x-z plane comprises each one of the associated plurality of dielectric materials and
wherein in the second lens, at least one cross-section of the plurality of dielectric materials in the y-z plane comprises only one of the associated plurality of dielectric materials.

10. The compound lens of claim 9, wherein:
the second lens has an identical side by side stack up of the plurality of dielectric materials as the first lens.

11. The compound lens of claim 10, wherein:
the first lens and the second lens each have an odd number of the plurality of dielectric materials.

12. The compound lens of claim 11, wherein:
the plurality of dielectric materials of the first lens 1 has mirror image symmetry in the x-z plane about the associated central one of the plurality of dielectric materials;
the plurality of dielectric materials of the second lens has mirror image symmetry in the y-z plane about the associated central one of the plurality of dielectric materials.

13. The compound lens of claim 10, wherein:
each dielectric material of the plurality of dielectric materials of the first lens has a Dk value initially calculated according to the following equation and tuned thereafter based on desired performance characteristics:
$$ϕ o - ϕ i = 2 π / λ c * t * SQRT ( D kj ) ;$$
where:
ϕi is a known incoming phase angle of the EM radiation to the compound lens;
ϕo is a desired output phase angle of the EM radiation from the compound lens;
Dkj is the Dk value of the jth dielectric material of the plurality of dielectric materials along the non-dominant field direction;
λc is the free space wavelength of the compound lens when operating at the desired center frequency (fc); and
t is the thickness of the plurality of dielectric materials in the z-direction.

14. An electromagnetic, EM, device, comprising:
a lens for use with a signal feed for shaping electromagnetic (EM) radiation energy originating from the signal feed when energized, the lens configured to operate at a defined center frequency (fc) having a free space wavelength (λc), the lens comprising:
a plurality of dielectric materials stacked side by side, wherein an adjacent one of the plurality of dielectric materials has a dielectric constant (Dk) value that is different from a Dk value of another adjacent one of the plurality of dielectric materials, the plurality of dielectric materials having an overall footprint (a×b) in an x-y plane and an overall thickness (t) in a z-direction, of an orthogonal x-y-z coordinate system;
wherein each cross-section of the plurality of dielectric materials in the x-y plane comprises each one of the plurality of dielectric materials;
wherein each cross-section of the plurality of dielectric materials in one of; the x-z plane, and the y-z plane, comprises each one of the plurality of dielectric materials;
wherein at least one cross-section of the plurality of dielectric materials in the other one of; the x-z plane, and the y-z plane, comprises only one of the plurality of dielectric materials; and
a signal feed disposed in EM signal communication with the associated lens.

15. The EM device of claim 14, wherein:
the associated lens or compound lens is disposed a distance (d) above the signal feed.

16. The EM device of claim 15, wherein:
the distance (d) is initially set equal to λ/2, and subsequently tuned to get an exact distance to achieve a desired phase center of the associated lens or compound lens, where the EM device is operational at the center frequency (fc) having an associated free space wavelength (λc).

17. The EM device of claim 15, further comprising:
a dielectric spacer disposed between the signal feed and the associated lens or compound lens.

18. The EM device of claim 17, wherein:
the dielectric spacer is disposed on the signal feed; and
the associated lens or compound lens is disposed on the dielectric spacer.

19. The EM device of claim 17, wherein:
the dielectric spacer has a Dk value of greater than 1 and less than 1.5.

20. The EM device of claim 17, further comprising:
a dielectric encapsulant disposed over and fixturing the lens or compound lens to the dielectric spacer and signal feed.

21. The EM device of claim 20, wherein:
the dielectric encapsulant has a Dk value of greater than 1 and less than 1.5.

22. The EM device of claim 14, wherein:
the signal feed comprises a waveguide and a slotted aperture.

23. The EM device of claim 22, wherein:
the overall footprint (a×b) of the associated lens or compound lens overlays at least the slotted apertures.

24. The EM device of claim 22, wherein:
the overall footprint (a×b) of the associated lens or compound lens overlays the waveguide and slotted aperture.

25. The EM device of claim 14, wherein:
the signal feed comprises a patch antenna comprising a signal line that passes through a ground plane and a dielectric substrate disposed on the ground plane, and a conductive patch disposed on the dielectric substrate, the signal line being disposed in electrical communication with the conductive patch.

26. The EM device of claim 14, wherein:
the signal feed comprises a chipset with at least one radiating element.

27. The EM device of claim 26, wherein:
the overall footprint (a×b) of the associated lens or compound lens overlays at least the signal feed.

28. The EM device of claim 25, wherein:
the overall footprint (a×b) of the associated lens or compound lens overlays the patch antenna, which comprises the signal line, the conductive patch, at least that portion of the dielectric substrate beneath the conductive patch, and a corresponding portion of the ground plane.

29. The EM device of claim 22, wherein:
the slotted aperture is linearly aligned with the x-axis;
each cross-section of the plurality of dielectric materials in the y-z plane comprises each one of the plurality of dielectric materials; and
at least one cross-section of the plurality of dielectric materials in the x-z plane comprises only one of the plurality of dielectric materials.

30. The EM device of claim 25, wherein:
a signal line to the patch is configured to produce an electric field (E-field) that is linearly aligned with the y-axis;
each cross-section of the plurality of dielectric materials in the x-z plane comprises each one of the plurality of dielectric materials; and
at least one cross-section of the plurality of dielectric materials in the y-z plane comprises only one of the plurality of dielectric materials.

31. The EM device of claim 25:
a signal line is configured to produce an electric field (E-field) that is linearly aligned with the y-axis;
in the first lens, each cross-section of the plurality of dielectric materials in the y-z plane comprises each one of the plurality of dielectric materials; and
in the first lens, at least one cross-section of the plurality of dielectric materials in the x-z plane comprises only one of the plurality of dielectric materials.

32. An antenna array, comprising
a plurality of electromagnetic (EM) devices, each EM device comprising:
a lens for use with a signal feed for shaping electromagnetic (EM) radiation energy originating from the signal feed when energized, the lens configured to operate at a defined center frequency (fc) having a free space wavelength (λc), the lens comprising:
a plurality of dielectric materials stacked side by side, wherein an adjacent one of the plurality of dielectric materials has a dielectric constant (Dk) value that is different from a Dk value of another adjacent one of the plurality of dielectric materials, the plurality of dielectric materials having an overall footprint (a×b) in an x-y plane and an overall thickness (t) in a z-direction, of an orthogonal x-y-z coordinate system;
wherein each cross-section of the plurality of dielectric materials in the x-y plane comprises each one of the plurality of dielectric materials;
wherein each cross-section of the plurality of dielectric materials in one of; the x-z plane, and the y-z plane, comprises each one of the plurality of dielectric materials;
wherein at least one cross-section of the plurality of dielectric materials in the other one of; the x-z plane, and the y-z plane, comprises only one of the plurality of dielectric materials; and
a signal feed disposed in EM signal communication with the associated lens,
wherein the plurality of EM devices are arranged in an X-by-Y array formation.
